(19) United States
(12) Patent Application Publication
(10) Pub. No.: US 2020/0096606 A1
(43) Pub. Date: Mar. 26, 2020

(54) VEHICLE INSPECTION SYSTEM AND VEHICLE INSPECTION METHOD

(71) Applicant: HONDA MOTOR CO., LTD., Tokyo (JP)

(72) Inventors: Michiaki Okubo, Hagagun (JP); Kenichiro Kurai, Hagagun (JP); Kazuyuki Fukamachi, Hagagun (JP); Yasuhiro Okuno, Hagagun (JP); Kazumori Sakai, Hagagun (JP)

(21) Appl. No.: 16/577,143

(22) Filed: Sep. 20, 2019

(30) Foreign Application Priority Data
Sep. 25, 2018 (JP) 2018-178949

(51) Int. Cl. G01S 7/40; G01B 11/26; G01B 11/14

(52) U.S. Cl. CPC G01S 7/4026; G01B 11/14; G01B 11/26

(57) ABSTRACT

The vehicle inspection system inspects a vehicle V in which a radar device R is attached to a vehicle body B. The vehicle inspection system includes: an adjustment target T that is movable in an inspection chamber Rb in which the vehicle body B is disposed; a first marker M1 that is attached to the vehicle body B; a second marker M2 that is attached to the adjustment target T; a position and posture calculation unit that calculates a position and a posture of the vehicle body B and the adjustment target T in the inspection chamber Rb by detecting a position and a posture of the first marker M1 and the second marker M2; and a target movement unit that moves at least one of the vehicle body B and the adjustment target T on the basis of a calculation result of the position and posture calculation unit.

This application is based on and claims the benefit of priority from Japanese Patent Application No. 2018-178949, filed on 25 Sep. 2018, the content of which is incorporated herein by reference.

### BACKGROUND OF THE INVENTION

### Field of the Invention

The present invention relates to a vehicle inspection system and a vehicle inspection method. More specifically, the invention relates to a vehicle inspection system and a vehicle inspection method for inspecting a vehicle in which an external environment sensor is attached to a vehicle body.

### Related Art

To realize a driving support function or an automatic driving function such as adaptive cruise control and an automatic brake system, an external environment sensor such as a radar device and a camera which detect an external environment is mounted on a vehicle. Particularly, the radar device has strong directivity, and thus it is necessary to attach the radar device in an appropriate direction with respect to a vehicle body to allow the driving support function or the automatic driving function to be appropriately exhibited. According to this, a manufacturing and inspection process of a vehicle on which the radar device is mounted includes an aiming process of adjusting an optical axis of the radar device attached to the vehicle body.

In the aiming process, for example, a target is installed at a predetermined position at the periphery of the vehicle installed in an inspection area. In addition, an electromagnetic wave is emitted from the radar device to the target, and an intensity distribution of the electromagnetic wave emitted from the radar device is measured by a measurement device provided in the target, or a reflected wave of the electromagnetic wave from the target is detected by the radar device to understand a deviation of an optical axis of the radar device with respect to a normal direction, and the optical axis of the radar device is adjusted so that the deviation disappears. According to this, in the aiming process, it is necessary to install the target at an appropriate position with respect to the vehicle to adjust the optical axis of the radar device with accuracy.

Japanese Unexamined Patent Application, Publication No. 2005-331353 discloses a positioning device that automatically determines a position of the target. In the positioning device, a plan-view image of a vehicle is photographed by a camera installed on the ceiling of an inspection area, the normal direction of the optical axis of the radar device is specified on the basis of the plan-view image, and the target is moved to a position at which the specified normal direction and a surface of the target are orthogonal to each other.

### SUMMARY OF THE INVENTION

As described above, in the positioning device disclosed in Japanese Unexamined Patent Application, Publication No. 2005-331353, the normal direction of the optical axis of the radar device is specified on the basis of the plan-view image of the vehicle. That is, it is difficult to understand an actual position and an actual posture of the vehicle in the inspection area with accuracy by the plan-view image, and thus it is difficult to specify the normal direction of the optical axis with accuracy in the positioning device disclosed in Japanese Unexamined Patent Application, Publication No. 2005-331353.

A detection error of the radar device which is caused by the deviation of the optical axis increases as a distance between an object and the radar device is longer. In recent years, it has been required that a position of an object can be detected by a radar device with accuracy up to sufficiently far away position, and thus there is a concern that it is difficult to adjust the optical axis of the radar device to a certain extent capable of realizing required accuracy in the positioning device of the related art.

An object of the invention is to provide a vehicle inspection system and a vehicle inspection method which are capable of installing a target at an appropriate position and in an appropriate posture with respect to a vehicle installed in an inspection area to adjust a sensor axis of an external environment sensor with accuracy.

(1) According to an aspect of the invention, there is provided a vehicle inspection system (for example, a vehicle inspection system S to be described later) that inspects a vehicle (for example, a vehicle V to be described later) in which an external environment sensor (for example, a radar device R to be described later) that detects an external environment is attached to a vehicle body (for example, a vehicle body B to be described later). The vehicle inspection system includes: an adjustment target (for example, an adjustment target T to be described later) that is installed in an inspection area (for example, an inspection chamber Rb to be described later) in which the vehicle body is disposed; a first marker (for example, a first marker M1 to be described later) that is attached to the vehicle body; a second marker (for example, a second marker M2 to be described later) that is attached to the adjustment target; a position and posture calculation unit (for example, a vehicle-body position and posture calculation unit 63 and a target position and posture calculation unit 64 to be described later) that calculates a position and a posture of the vehicle body and the adjustment target in the inspection area by detecting a position and a posture of the first marker and the second marker; and a movement unit (for example, a target movement unit 67 to be described later) that moves at least one of the vehicle body and the adjustment target on the basis of a calculation result of the position and posture calculation unit.

(2) In this case, the vehicle inspection system may further include a confronting device (for example, confronting devices 15L, 15R, 17L, and 17R to be described later) that secures a confronting posture of the vehicle body; and a first marker position and posture calculation unit (for example, a first marker position and posture calculation unit 61 to be described later) that calculates the position and the posture of the first marker with reference to a predetermined reference point (for example, an inspection reference point Q to be described later) defined on the vehicle body in a state of securing the confronting posture by the confronting device. The position and posture calculation unit may calculate the position and the posture of the vehicle body and the adjustment target in the inspection area by using a detection result of the position and the posture of the first marker and the second marker, and a calculation result of the first marker position and posture calculation unit.

(3) In this case, the position and posture calculation unit may detect the position and the posture of the first marker and the second marker by using a plurality of cameras (for example, cameras Cb to be described later) installed with predetermined intervals at an outer periphery of the inspection area, and images of the first marker and the second marker which are photographed by the plurality of cameras.

(4) According to another aspect of the invention, there is provided a vehicle inspection method of inspecting a vehicle (for example, a vehicle V to be described later) in which an external environment sensor (for example, a radar device R to be described later) that detects an external environment is attached to a vehicle body (for example, a vehicle body B to be described later). The method includes: a process of moving the vehicle body to a first inspection area (for example, an inspection chamber Ra to be described later) in which a confronting device (for example, confronting devices 15L, 15R, 17L, and 17R to be described later) that secures a confronting posture of the vehicle body is installed (for example, S1 in FIG. 3 to be described later); a process of calculating a position and a posture of a first marker (for example, a first marker M1 to be described later) attached to the vehicle body with reference to a predetermined reference point (for example, an inspection reference point Q to be described later) defined on the vehicle body while securing a confronting posture by the confronting device in the first inspection area (for example, S6 in FIG. 3 to be described later); a process of moving the vehicle body to a second inspection area (for example, an inspection chamber Rb to be described later) in which an adjustment target (for example, an adjustment target T to be described later) to which a second marker is attached is installed (for example, S11 in FIG. 8 to be described later); a process of detecting a position and a posture of the first marker and the second marker in the second inspection area (for example, S18 in FIG. 8 to be described later); a process of calculating a position and a posture of the vehicle body and the adjustment target in the second inspection area by using the detected position and posture of the first marker and the second marker, and the calculated position and posture of the first marker with reference to the reference point (for example, S18 in FIG. 8 to be described later); a process of moving at least one of the vehicle body and the adjustment target on the basis of the calculated position and posture of the vehicle body and the adjustment target in the second inspection area (for example, S18 in FIG. 8 to be described later); and a process of adjusting a direction of a sensor axis of the external environment sensor by using the adjustment target (for example, S19 in FIG. 8 to be described later).

(1) In the vehicle inspection system of the invention, the position and posture calculation unit calculates the position and the posture of the vehicle body and the adjustment target in the inspection area by detecting the position and the posture of the first marker and the second marker which are attached to the vehicle body and the adjustment target, and the movement unit moves at least one of the vehicle body and the adjustment target on the basis of the position and the posture of the vehicle body and the adjustment target which are obtained by the position and posture calculation unit. As described above, in the invention, the position and the posture of the vehicle body and the adjustment target are calculated by detecting the position and the posture of the first marker and the second marker. Accordingly, it is possible to understand an actual position and an actual posture of the vehicle body and the adjustment target in the inspection area with accuracy, and it is possible to install the adjustment target at an appropriate position and in an appropriate posture with respect to the vehicle body that is installed in the inspection area to adjust a sensor axis of the external environment sensor with accuracy.

In addition, a detection error of the external environment sensor due to a deviation of the sensor axis increases as a distance between an object and the external environment sensor is longer. Therefore, it is possible to adjust the sensor axis with accuracy as a distance between the installation position of the adjustment target and the external environment sensor is longer, but it is necessary to secure a wide inspection area to lengthen an interval between the adjustment target and the external environment sensor. In contrast, in the invention, as described above, the adjustment target is installed at an appropriate position and in an appropriate posture, and thus it is possible to shorten the interval between the adjustment target and the external environment sensor while securing sufficient adjustment accuracy of the sensor axis. Accordingly, according to the vehicle inspection system of the invention, it is possible to make the inspection area compact while adjusting the sensor axis with accuracy.

(2) A position and a posture of the first marker attached to the vehicle body are different for every vehicle. Therefore, in the vehicle inspection system of the invention, the confronting device secures the confronting posture of the vehicle body, the first marker position and posture calculation unit calculates the position and the posture of the first marker with reference to a predetermined reference point defined on the vehicle body in a state of securing the confronting posture by the confronting device, and the position and posture calculation unit calculates the position and the posture of the vehicle body and the adjustment target in the inspection area by using a detection result of the position and the posture of the first marker and the second marker, and the position and the posture of the first marker which are calculated by the first marker position and posture calculation unit. In the invention, the first marker position and posture calculation unit calculates the position and the posture of the first marker with reference to a reference point in a state of securing the confronting posture by the confronting device, and thus it is possible to calculate the position and the posture of the first marker with reference to the reference point with accuracy. In addition, according to this, it is possible to accurately understand an actual position and an actual posture of the vehicle body in the inspection area by the position and posture calculation unit, and it is possible to install the adjustment target at an appropriate position and in an appropriate posture with respect to the vehicle body installed in the inspection area to adjust the sensor axis of the external environment sensor with accuracy.

In addition, in the vehicle inspection system of the invention, the first inspection area in which inspection of a vehicle is performed by using the confronting device and the second inspection area in which adjustment of the sensor axis of the external environment sensor is performed by using the adjustment target can be individually provided. In addition, in this case, it is possible to calculate a position and a posture of the first marker with reference to a reference point by using the confronting device in the first inspection area with accuracy before performing adjustment of the sensor axis of the external environment sensor in the second inspection area. Accordingly, it is possible to perform individual processes in the first inspection area and the second inspection area, and thus it is possible to shorten time taken for adjustment of the sensor axis of the external environment sensor.

(3) In the vehicle inspection system of the invention, the position and posture calculation unit detects the position and the posture of the first marker and the second marker by using a plurality of cameras which are installed with predetermined intervals at an outer periphery of the inspection area and images of the first marker and the second marker which are photographed by the plurality of cameras. According to this, it is possible to accurately understand an actual position and an actual posture of the vehicle body and the adjustment target in the inspection area by the position and posture calculation unit, and it is possible to install the adjustment target at an appropriate position and in an appropriate posture with respect to the vehicle body installed in the inspection area to adjust the sensor axis of the external environment sensor with accuracy.

(4) In the vehicle inspection method of the invention, the vehicle is moved to the first inspection area in which the confronting device that secures the confronting posture of the vehicle body is installed, and the position and the posture of the first marker with reference to a predetermined reference point are calculated while securing the confronting posture by the confronting device in the first inspection area. Next, the vehicle is moved to the second inspection area, the position and the posture of the first marker and the second marker are detected in the second inspection area, the position and the posture of the vehicle body and the adjustment target in the second inspection area are calculated by using the detected position and posture of the first marker and the second marker, and the calculated position and posture of the first marker with reference to the reference point, in the first inspection area, at least one of the vehicle body and the adjustment target is moved on the basis of the position and the posture of the vehicle body and the adjustment target, and the direction of the sensor axis of the external environment sensor is adjusted by using the adjustment target. In the invention, the position and the posture of the vehicle body and the adjustment target are calculated by detecting the position and the posture of the first marker and the second marker. Accordingly, it is possible to accurately understand an actual position and an actual posture of the vehicle body and the adjustment target in the second inspection area, and thus it is possible to install the adjustment target at an appropriate position and in an appropriate posture with respect to the vehicle body in the second inspection area, and it is possible to adjust the sensor axis of the external environment sensor with accuracy.

In addition, in the vehicle inspection method of the invention, a position and a posture of the first marker with reference to a reference point, which are necessary to calculate the position and the posture of the vehicle body and the adjustment target in the second inspection area with accuracy, are acquired in advance in the first inspection area before moving the vehicle to the second inspection area, and thus it is possible to shorten time taken for adjustment of the sensor axis of the external environment sensor in the second inspection area.

### BRIEF DESCRIPTION OF THE DRAWINGS

FIG. 1 is a view schematically illustrating a configuration of a vehicle inspection system according to an embodiment of the invention.

FIG. 2A is a plan view of an alignment system.

FIG. 2B is a side view of the alignment system.

FIG. 3 is a flowchart illustrating a specific procedure of an alignment tester process using the alignment system.

FIG. 4A is a plan view of an optical axis adjustment system.

FIG. 4B is a side view of the optical axis adjustment system.

FIG. 5 is a functional block diagram of a control device.

FIG. 6 is a view illustrating a procedure of calculating an attachment position of a radar device and a direction of an optical axis in a radar attachment position and direction calculation unit.

FIG. 7A is a view illustrating a procedure of calculating a normal position and a normal posture of an adjustment target in a normal posture calculation unit.

FIG. 7B is a view illustrating a procedure of calculating the normal position and the normal posture of the adjustment target in the normal posture calculation unit.

FIG. 8 is a flowchart illustrating a specific procedure of an aiming process using the optical axis adjustment system.

### DETAILED DESCRIPTION OF THE INVENTION

Hereinafter, a configuration of a vehicle inspection system S according to an embodiment of the invention will be described in detail with reference to the accompanying drawings.

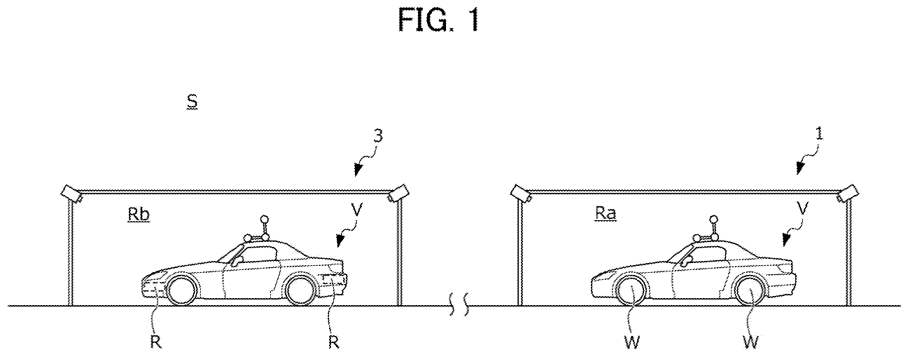

FIG. 1 is a view schematically illustrating a configuration of the vehicle inspection system S. The vehicle inspection system S is a facility that is used when inspecting a vehicle V to which a plurality of radar devices R are attached as an external environment sensor that detects an external environment. FIG. 1 illustrates configurations of an alignment system 1 and an optical axis adjustment system 3 which are facilities used when executing, particularly, an alignment tester process and an aiming process among a plurality of inspection processes on the vehicle V by using the vehicle inspection system S.

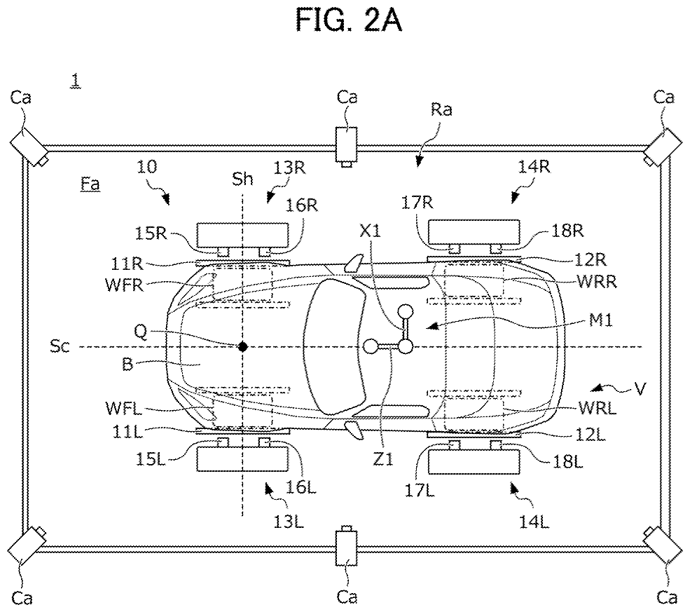

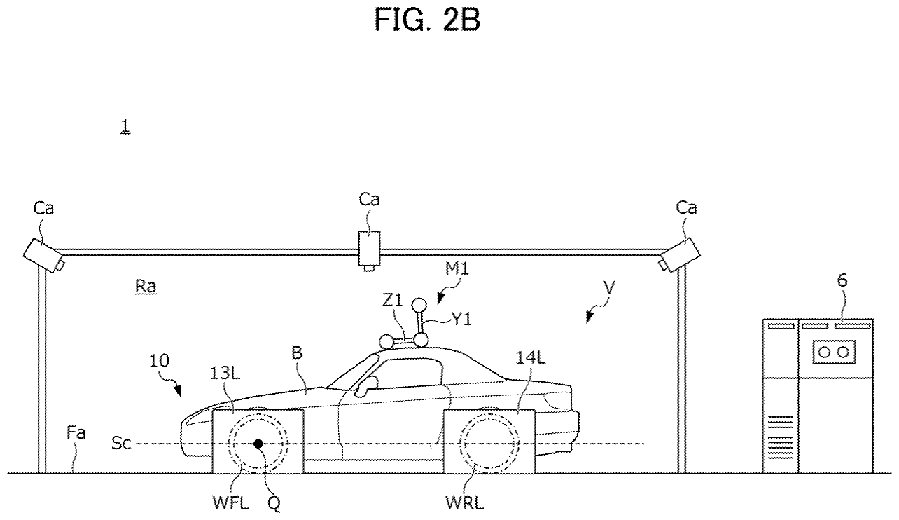

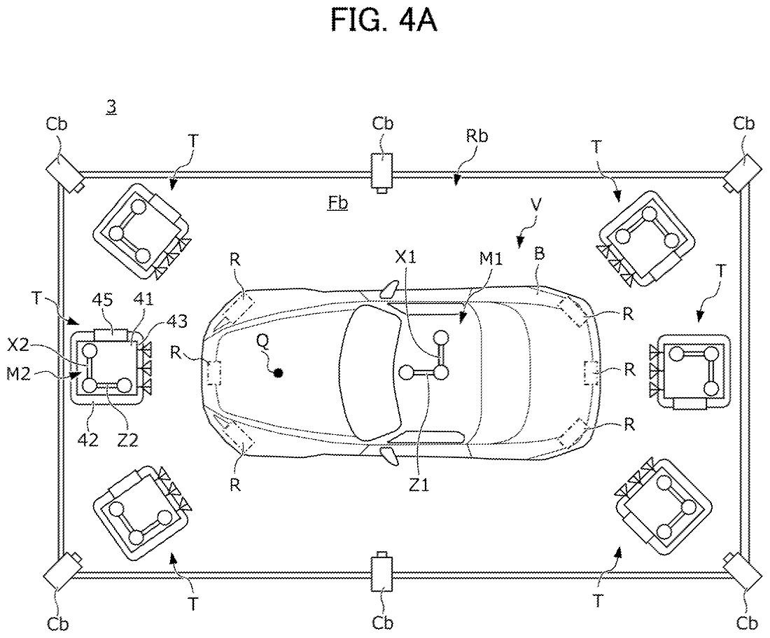

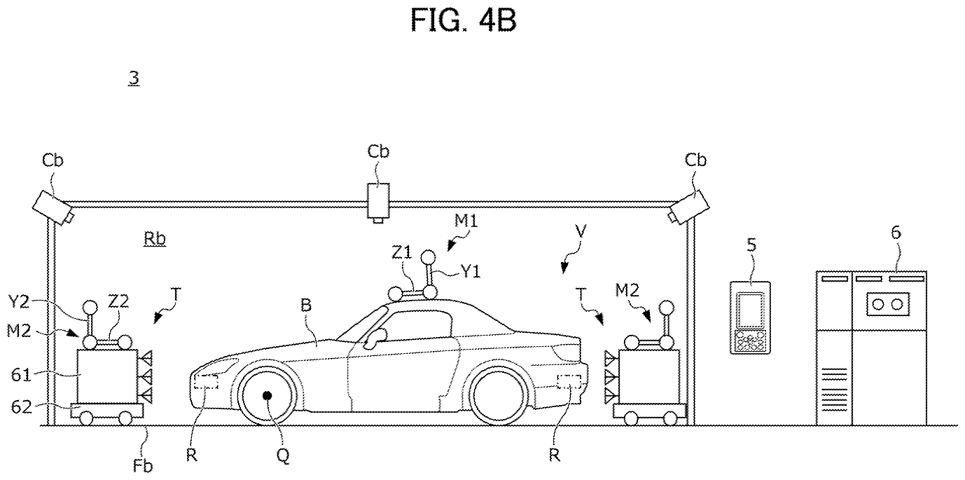

In the alignment tester process, an attachment angle, an attachment position, and the like of wheels W, which are movable components attached to a vehicle body of the vehicle V, with respect to an axle are adjusted in an inspection chamber Ra in which the alignment system 1 to be described later with reference to FIG. 2A and FIG. 2B is installed. In the aiming process, a direction of an optical axis of each of the radar devices R with respect to the vehicle V after being subjected to the alignment tester process is adjusted in an inspection chamber Rb in which the optical axis adjustment system 3 to be described later with reference to FIG. 4A and FIG. 4B is installed.

Hereinafter, detailed configurations of the alignment system 1 and the optical axis adjustment system 3 will be sequentially described with reference to the accompanying drawings.

FIG. 2A is a plan view of the alignment system 1, and FIG. 2B is a side view of the alignment system 1.

The alignment system 1 includes an alignment measurement device 10 installed on a floor surface Fa of the inspection chamber Ra, a plurality of (for example, six) cameras Ca which are installed on the ceiling of the inspection chamber Ra, and a control device 6 that processes an image captured by the cameras Ca.

The alignment measurement device 10 includes front wheel guides 11L and 11R and rear wheel guides 12L and 12R which are installed on the floor surface Fa, front housings 13L and 13R which are installed on an outer side of the front wheel guides 11L and 11R in a vehicle width direction, and rear housings 14L and 14R which are installed on an outer side of the rear wheel guides 12L and 12R in the vehicle width direction.

The vehicle V is stopped at a defined position in the inspection chamber Ra by advancing front wheels WFL and WFR, and rear wheels WRL and WRR along the front wheel guides 11L and 11R and the rear wheel guides 12L and 12R.

The front housings 13L and 13R are respectively provided with front wheel confronting devices 15L and 15R and front wheel sensors 16L and 16R, and the rear housings 14L and 14R are respectively provided with rear wheel confronting devices 17L and 17R and rear wheel sensors 18L and 18R.

The front wheel sensors 16L and 16R and the rear wheel sensors 18L and 18R respectively measure a toe angle, a caster angle, or the like of the front wheels WFL and WFR and the rear wheels WRL and WRR. The front wheel confronting devices 15L and 15R respectively press the front wheels WFL and WFR to set a position of a front portion of a vehicle body B to a defined position. The rear wheel confronting devices 17L and 17R respectively press the rear wheels WRL and WRR to set a position of a rear portion of the vehicle body B to a defined position. Note that, in the following description, a posture of the vehicle body B, which is realized in the inspection chamber Ra by using the front wheel confronting devices 15L and 15R and the rear wheel confronting devices 17L and 17R, is referred to as a confronting posture. In addition, in a state in which the confronting posture is secured by the confronting devices 15L, 15R, 17L, and 17R, a position and a posture of an axle Sh of the front wheels WFL and WFR in the inspection chamber Ra are fixed, and thus the position and the posture can be specified with accuracy. Here, in the following description, an inspection reference point Q is defined to the center of the axle Sh, that is, an intersection between the axle Sh and a vehicle body central axis Sc that extends along a front and rear direction at a vehicle width direction center of the vehicle body B.

A first marker M1 is attached to a roof panel that is an upper portion of the vehicle body B. The first marker M1 has a predetermined three-dimensional shape. More specifically, the first marker M1 is constructed by attaching four spherical reflection markers to ends of three axis bodies X1, Y1, and Z1 which are orthogonal to each other. The first marker M1 is attached to the roof panel of the vehicle body B with a tape (not illustrated) so that the axis body X1 becomes approximately parallel to a vehicle width direction of the vehicle body B, the axis body Y1 becomes approximately to a vertical direction of the vehicle body B, and the axis body Z1 becomes approximately parallel to an advancing direction of the vehicle body B.

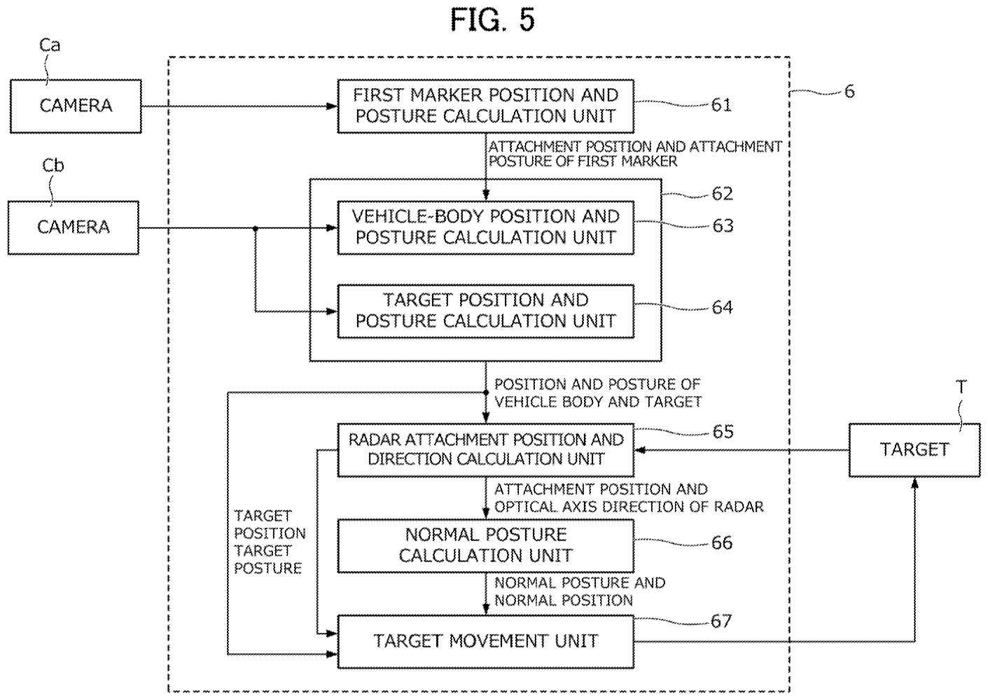

The six cameras Ca are installed with predetermined intervals at ceiling side portions of side walls which partition the inspection chamber Ra to surround the vehicle body B in a state in which a confronting posture is secured by the confronting devices 15L, 15R, 17L, and 17R. The cameras Ca photograph the vehicle body B and the first marker M1 attached to the roof panel in a state in which the confronting posture is secured in correspondence with a command from the control device 6, and transmits image data obtained through the photographing to the control device 6. The control device 6 calculates a position and a posture of the first marker M1 with reference to the inspection reference point Q of the vehicle body B by using the image data obtained by the cameras Ca as to be described later with reference to FIG. 5.

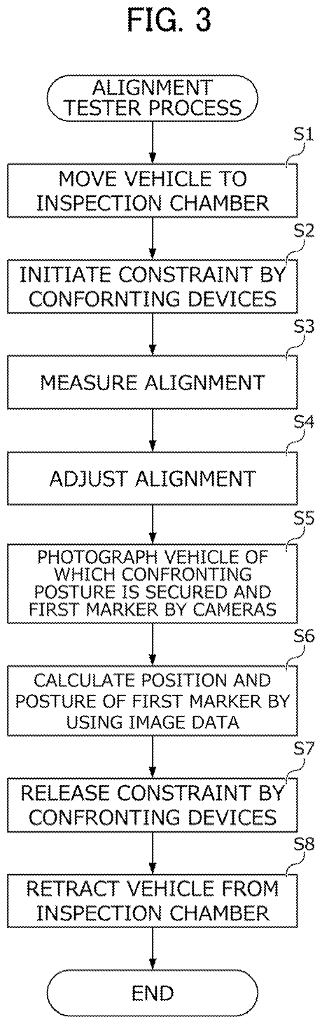

FIG. 3 is a flowchart illustrating a specific procedure of an alignment tester process using the alignment system 1 as described above.

First, in S1, an operator moves the vehicle V to which the first marker M1 is attached in advance to the inspection chamber Ra in which the alignment system 1 is installed. In S2, the operator initiates constraint of the vehicle body B by the confronting devices 15L, 15R, 17L, and 17R. Then, the vehicle body B is maintained in the confronting posture until the constraint by the confronting devices 15L, 15R, 17L, and 17R is released. In S3, the operator measures alignment by using the alignment measurement device 10, and adjusts the alignment in S4 by using a measurement result in S3.

In S5, the operator photographs the vehicle body B and the first marker M1 after alignment adjustment by using the six cameras Ca. In S6, the control device 6 calculates a position and a posture of the first marker M1 with reference to the inspection reference of the vehicle body B by using image data obtained by the six cameras Ca. In S7, the operator releases the constraint of the vehicle body B by the confronting devices 15L, 15R, 17L, and 17R. In S8, the operator retracts the vehicle V from the inspection chamber Ra.

FIG. 4A is a plan view of the optical axis adjustment system 3, and FIG. 4B is a side view of the optical axis adjustment system 3.

The vehicle V of which the alignment is adjusted by using the above-described alignment system 1 is conveyed to the optical axis adjustment system 3. Hereinafter, description will be given of a case where six radar devices R are attached to the vehicle body B of the vehicle V, and in the optical axis adjustment system 3, directions of optical axes of the six radar devices R are adjusted. As illustrated in FIG. 4A, the radar devices R are attached one by one to a central portion, a leftward portion, and a rightward portion on a front side of the vehicle body B, and a central portion, a leftward portion, and a rightward portion on a rear side of the vehicle body B.

The optical axis adjustment system 3 includes a plurality of (for example, six; the same number as in the radar devices mounted on the vehicle body B) adjustment targets T which are movable on a floor surface Fb of the inspection chamber Rb, a plurality of (for example, six) cameras Cb installed on the ceiling of the inspection chamber Rb, a control device 6 that processes an image captured by the six cameras Cb, and a vehicle inspection device 5 that can perform communication with the vehicle V. As described above, the first marker M1 is attached to the roof panel of the vehicle body B as described above.

Each of the adjustment targets T includes an electromagnetic wave characteristic measurement device 41 that measures characteristics (for example, an intensity distribution, a phase, or the like of the electromagnetic wave) of an electromagnetic wave (for example, a millimeter wave emitted from the radar devices R), and a cart 42 that support a lower portion of the electromagnetic wave characteristic measurement device 41. The electromagnetic wave characteristic measurement device 41 and the cart 42 can perform wireless communication with the control device 6.

The electromagnetic wave characteristic measurement device 41 measures an intensity distribution of an electromagnetic wave incident to an incident surface 43, and wirelessly transmits intensity distribution data that is obtained through the measurement to the control device 6. The cart 42 moves on the floor surface Fb of the inspection chamber Rb in correspondence with a command signal wirelessly transmitted from the control device 6.

In addition, a reflector 45 that reflects the electromagnetic wave emitted from the radar devices R is attached to a surface different from the incident surface 43 of the electromagnetic wave characteristic measurement device 41.

A second marker M2 is attached to a predetermined position of an upper portion of the electromagnetic wave characteristic measurement device 41. The second marker M2 has a three-dimensional shape as in the first marker M1. More specifically, the second marker M2 is constructed by attaching four spherical reflection markers to ends of three axis bodies X2, Y2, and Z2 which are orthogonal to each other. The second marker M2 is attached to an upper portion of the electromagnetic wave characteristic measurement device 41 with a tape (not illustrated) so that the axis body X2 becomes approximately parallel to the incident surface 43 of the electromagnetic wave characteristic measurement device 41, the axis body Y2 becomes approximately parallel to the vertical direction, and the axis body Z2 becomes approximately vertical to the incident surface 43.

The six cameras Cb are installed with predetermined intervals at ceiling side portions of side walls which partition the inspection chamber Rb to surround the vehicle body B installed in the inspection chamber Rb. The cameras Cb photograph the vehicle body B and the first marker M1 attached to the roof panel of the vehicle body B, and the six adjustment targets T and the second markers M2 attached to defined positions of upper portions of the adjustment targets T, and transmits image data obtained through the photographing to the control device 6.

The vehicle inspection device 5 is connected to a vehicle ECU (not illustrated) mounted on the vehicle body B through a communication line, and can perform communication with the vehicle ECU. The vehicle ECU emits an electromagnetic wave (for example, a millimeter wave) from the radar devices R mounted on the vehicle body B or adjusts a direction of an optical axis of each of the radar devices R in correspondence with a command signal transmitted from the vehicle inspection device 5.

FIG. 5 is a functional block diagram of the control device 6. The control device 6 is a computer including a CPU, a ROM, a RAM, a wireless communication interface, and the like. The control device 6 functions as a first marker position and posture calculation unit 61, a position and posture calculation unit 62, a radar attachment position and direction calculation unit 65, a normal posture calculation unit 66, and a target movement unit 67 to be described later by executing various kinds of operation processing in the CPU in accordance with a program stored in the ROM.

The first marker position and posture calculation unit 61 calculates a position and a posture of the first marker M1 with reference to the inspection reference point Q defined on the axle Sh of the vehicle body B in a state of securing the confronting posture by the confronting devices 15L, 15R, 17L, and 17R by using image data transmitted from the six cameras Ca in the alignment tester process described with reference to FIG. 3. As described above, an attachment position or an attachment posture of the first marker M1 in the vehicle body B is slightly different for every vehicle V. Accordingly, the first marker position and posture calculation unit 61 calculates the position and the posture of the first marker M1 with reference to the inspection reference point Q in a state of securing the confronting posture for every vehicle V.

The position and posture calculation unit 62 includes a vehicle-body position and posture calculation unit 63 and a target position and posture calculation unit 64, and calculates a position and a posture of the vehicle body B and the adjustment targets T in the inspection chamber Rb by using the units.

The vehicle-body position and posture calculation unit 63 calculates a position and a posture of the vehicle body B in the inspection chamber Rb by using the image data transmitted from the six camera Cb installed in the inspection chamber Rb, and the position and the posture of the first marker M1 with reference to the inspection reference point Q which are calculated by the first marker position and posture calculation unit 61. More specifically, the vehicle-body position and posture calculation unit 63 detects the position and the posture of the first marker M1 in the inspection chamber Rb by using the image data transmitted from the six cameras Cb, and calculates the position and the posture of the vehicle body B in the inspection chamber Rb by using the detection result of the position and the posture of the first marker M1 and the calculation result of the first marker position and posture calculation unit 61. The position and the posture of the vehicle body B which are calculated by the vehicle-body position and posture calculation unit 63 are transmitted to the radar attachment position and direction calculation unit 65, the normal posture calculation unit 66, and the target movement unit 67.

The target position and posture calculation unit 64 calculates a position and a posture of the six adjustment targets T in the inspection chamber Rb by using the image data transmitted from the six cameras Cb installed in the inspection chamber Rb. The above-described second marker M2 is attached at a predetermined position of each of the adjustment targets T, and information relating to an attachment position and an attachment posture of the second marker M2 is stored in the target position and posture calculation unit 64. The target position and posture calculation unit 64 detects the position and the posture of the second marker M2 of the adjustment target T in the inspection chamber Rb by using the image data transmitted from the six cameras Cb, and calculates the position and the posture of the adjustment target T in the inspection chamber Rb by using the calculation result of the position and the posture of the second marker M2, and the information relating to the predetermined attachment position and attachment posture of the second marker M2. The position and the posture of the vehicle body B which are calculated by the target position and posture calculation unit 64 is transmitted to the radar attachment position and direction calculation unit 65, the normal posture calculation unit 66, and the target movement unit 67.

The target movement unit 67 moves the cart 42 of the adjustment target T so that matching is established between the position and the posture of the adjustment target T which are calculated by the target position and posture calculation unit 64, and a target position and a target posture of the adjustment target T which are calculated in accordance with a procedure to be described later by the radar attachment position and direction calculation unit 65 or a normal position and a normal posture of the adjustment target T which are calculated in accordance with a procedure to be described later by the normal posture calculation unit 66.

The radar attachment position and direction calculation unit 65 calculates an attachment position of each of the radar devices R attached to the vehicle body B and a direction of an optical axis of the radar device R by using the position and the posture of the vehicle body B and the adjustment target T which are calculated by the position and posture calculation unit 62, and the intensity distribution data transmitted from the electromagnetic wave characteristic measurement device 41 provided in the adjustment target T.

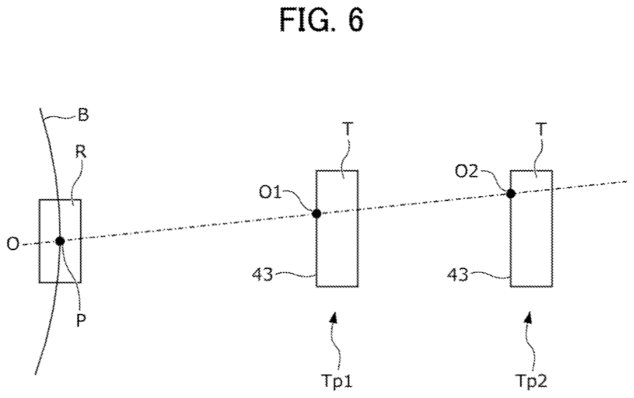

FIG. 6 is a view illustrating a procedure of calculating a position of an attachment point P of the radar device R and a direction of an optical axis O in the radar attachment position and direction calculation unit 65.

As illustrated in FIG. 6, the radar attachment position and direction calculation unit 65 changes a position of the adjustment target T between a first position Tp1 and a second position Tp2 that is further distant from the vehicle body B in comparison to the first position Tp1, and calculates a position of the attachment point P of the radar device R with respect to the vehicle body B in a three-dimensional space and a direction of the optical axis O in a three-dimensional space by using the intensity distribution data of the electromagnetic wave of the radar device R which is obtained by the adjustment target T installed at the positions Tp1 and Tp2.

More specifically, the radar attachment position and direction calculation unit 65 sets a target position of the adjustment target T to the first position Tp1, moves the adjustment target T to the first position Tp1 by using the target movement unit 67, and calculates a position of a point at which an electromagnetic wave intensity becomes the maximum from the intensity distribution data obtained by the adjustment target T. As described above, the position of the point at which the electromagnetic wave intensity calculated by the radar attachment position and direction calculation unit 65 becomes the maximum corresponds to an intersection O1 between the optical axis O and the incident surface 43 of the adjustment target T installed at the first position Tp1.

In addition, the radar attachment position and direction calculation unit 65 sets the target position of the adjustment target T to the second position Tp2, moves the adjustment target T to the second position Tp2 by using the target movement unit 67, and calculates a position of a point at which the electromagnetic wave intensity becomes the maximum from the intensity distribution data obtained by the adjustment target T. As described above, the position of the point at which the electromagnetic wave intensity calculated by the radar attachment position and direction calculation unit 65 becomes the maximum corresponds to an intersection O2 between the optical axis O and the incident surface 43 of the adjustment target T installed at the second position Tp2.

As described above, the radar attachment position and direction calculation unit 65 calculates a direction of the optical axis O as a line segment passing through the two intersections O1 and O2 by using the positions of the two intersections O1 and O2. In addition, the radar attachment position and direction calculation unit 65 calculates a position of the attachment point P of the radar device R in a three-dimensional space by an intersection between an extension line of the line segment passing through the intersections O1 and O2 calculated as described above, and the vehicle body B. As described above, the radar attachment position and direction calculation unit 65 calculates the position of the attachment point P of the radar device R attached to the vehicle body B in a three-dimensional space, and a direction of the optical axis O in a three-dimensional space.

Returning to FIG. 5, the normal posture calculation unit 66 calculates a normal position and a normal posture of the adjustment target T on the basis of the attachment position of the radar device R and the direction of the optical axis which are calculated by the radar attachment position and direction calculation unit 65. The target movement unit 67 moves the adjustment target T to be the normal position and the normal posture which are calculated by the normal posture calculation unit 66. Here, the normal position and the normal posture of the adjustment target T correspond to a position and a posture of the adjustment target T to be installed to adjust the direction of the optical axis so that the direction of the optical axis of the radar device R becomes the normal direction.

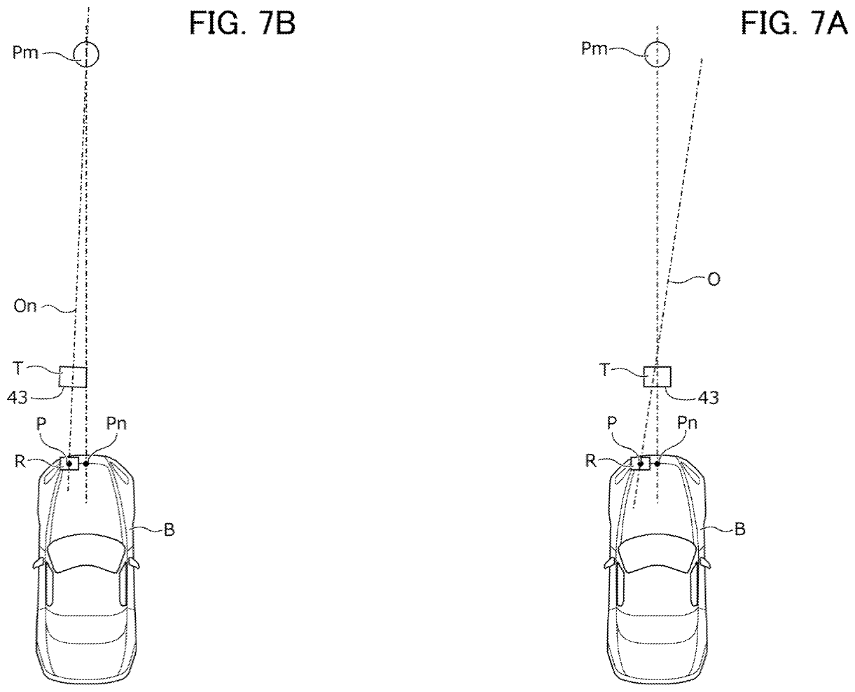

FIG. 7A and FIG. 7B are views illustrating a procedure of calculating the normal position and the normal posture of the adjustment target T in the normal posture calculation unit 66. Note that, FIG. 7A and FIG. 7B illustrate a case where the radar device R is attached to the vehicle body B at a position that extremely deviates from a designed attachment point Pn along a right and left direction for easy explanation. However, actually, the radar device R is attached at a position that deviates from the designed attachment point Pn along not only the right and left direction but also an upper and lower direction, but illustration on the deviation along the upper and lower direction will be omitted.

First, as illustrated in FIG. 7A and FIG. 7B, the longest target detection point Pm of the radar device R is set to a position that is distant from the designed attachment point Pn of the radar device R by a predetermined maximum detection distance (for example, 100 m). Note that, a position of the designed attachment point Pn in a three-dimensional space can be calculated on the basis of the position and the posture of the vehicle body B in the inspection chamber Rb which are calculated by the vehicle-body position and posture calculation unit 63. Accordingly, the position of the longest target detection point Pm in a three-dimensional space can also be calculated on the basis of the position and the posture of the vehicle body B in the inspection chamber Rb which are calculated by the vehicle-body position and posture calculation unit 63.

As illustrated in FIG. 7A, the radar device R is attached to the attachment point P that is spaced away from the designed attachment point Pn of the vehicle body B, and a direction of the optical axis O is not adjusted, and thus the optical axis O does not pass through the original longest target detection point Pm.

Therefore, the normal posture calculation unit 66 calculates a normal optical axis On that connects the attachment point P and the longest target detection point Pm by using a calculation result of the radar attachment position and direction calculation unit 65 as illustrated in FIG. 7B. In addition, the normal posture calculation unit 66 calculates a normal position and a normal posture of the adjustment target T so that the incident surface 43 of the adjustment target T becomes orthogonal to the normal optical axis On and the normal optical axis On interests the center of the incident surface 43. According to this, the normal posture calculation unit 66 can calculate the normal position and the normal posture of the adjustment target T to confront the radar device R between the radar device R attached to the attachment point P and the longest target detection point Pm.

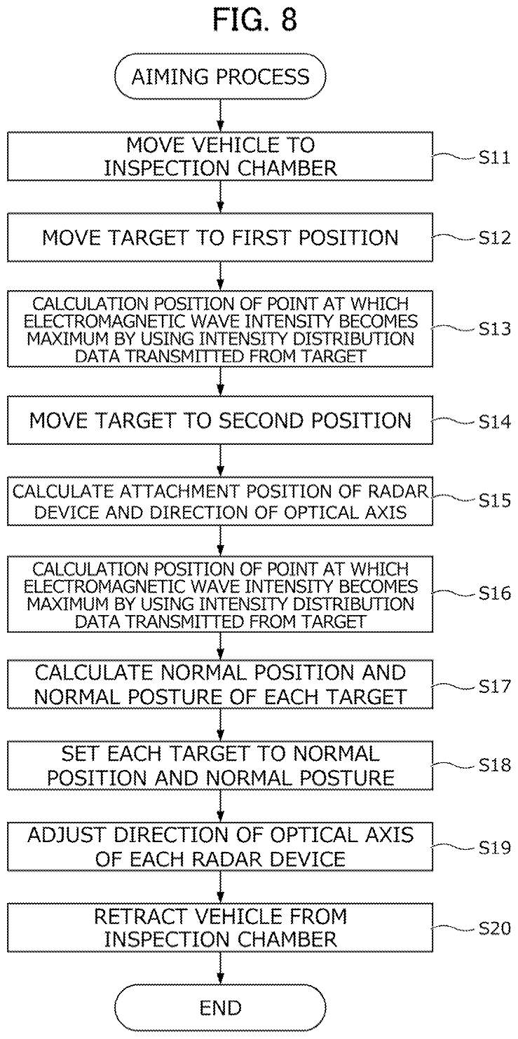

FIG. 8 is a flowchart illustrating a specific procedure of an aiming process using the optical axis adjustment system 3 described above.

First, in S11, the operator moves the vehicle V after being subjected to the alignment tester process in FIG. 3 to the inspection chamber Rb in which the optical axis adjustment system 3 is installed. In S12, the radar attachment position and direction calculation unit 65 of the control device 6 moves each of the adjustment targets T to the first position Tp1 determined in advance, and makes the incident surface 43 of the adjustment target T face each of the radar devices R attached to the vehicle body B. In S13, the operator operates the vehicle inspection device 5 to emit an electromagnetic wave from the radar device R and to receive the electromagnetic wave by the adjustment target T. In addition, the radar attachment position and direction calculation unit 65 calculates a position of the intersection O1 that is a point at which the electromagnetic wave intensity becomes the maximum by using the intensity distribution data transmitted from the adjustment target T.

In S14, the radar attachment position and direction calculation unit 65 moves the adjustment target T to the second position Tp2 away from the radar device R. In S15, the operator operates the vehicle inspection device 5 to emit an electromagnetic wave from the radar device R and to receive the electromagnetic wave by the adjustment target T. In addition, the radar attachment position and direction calculation unit 65 calculates a position of the intersection O2 that is a point at which the electromagnetic wave intensity becomes the maximum by using the intensity distribution data transmitted from the adjustment target T.

In S16, the radar attachment position and direction calculation unit 65 calculates a position of the attachment point P of the radar device R attached to the vehicle body B in a three-dimensional space and a direction of the optical axis O in a three-dimensional space by using positions of the two intersections O1 and O2.

In S17, the normal posture calculation unit 66 calculates a normal position and a normal posture of the adjustment target T on the basis of the position of the attachment point P of the radar device R and the direction of the optical axis O which are calculated by the radar attachment position and direction calculation unit 65.

In S18, the target movement unit 67 moves the cart 42 of the adjustment target T so that matching is established between the position and the posture of the adjustment target T which are calculated by the target position and posture calculation unit 64, and the normal position and the normal posture of the adjustment target T which are calculated by the normal posture calculation unit 66. According to this, the adjustment target T is installed at the normal position and in the normal posture which are determined in correspondence with the attachment position of the radar device R and the direction of the optical axis.

In S19, the operator adjusts the direction of the optical axis O of the radar device R by using the adjustment target T that is installed to be the normal position and the normal posture with respect to the radar device R. More specifically, an electromagnetic wave is emitted from the radar device R after the reflector T provided in the adjustment target T is made to face the radar device R, and the electromagnetic wave reflected from the reflector T is received by the radar device R. According to this, a deviation between the optical axis O of the radar device R and the normal optical axis On is understood and the direction of the optical axis O of the radar device R is adjusted so that the deviation disappears. In S20, the operator retracts the vehicle V from the inspection chamber Rb.

According to the vehicle inspection system S and the vehicle inspection method according to this embodiment, it is possible to attain the following effects.

(1) In the vehicle inspection system S, the position and posture calculation unit 62 calculates the position and the posture of the vehicle body B and the adjustment target T in the inspection chamber Rb by detecting the position and the posture of the first marker M1 and the second marker M2 which are attached to the vehicle body B and the adjustment target T, and the target movement unit 67 moves the adjustment target T on the basis of the position and the posture of the vehicle body B and the adjustment target T which are obtained by the position and posture calculation unit 62. As described above, in the vehicle inspection system S, the position and the posture of the vehicle body B and the adjustment target T are calculated by detecting the position and the posture of the first marker M1 and the second marker M2. Accordingly, it is possible to understand an actual position and an actual posture of the vehicle body B and the adjustment target T in the inspection chamber Rb with accuracy, and it is possible to install the adjustment target T at an appropriate position and in an appropriate posture with respect to the vehicle body B that is installed in the inspection chamber Rb to adjust an optical axis O of the radar device R with accuracy.

In addition, a detection error of the radar device R due to a deviation of the optical axis O increases as a distance between an object and the radar device R is longer. Therefore, it is possible to adjust the optical axis O with accuracy as a distance between the installation position of the adjustment target T and the radar device R is longer, but it is necessary to secure a wide inspection chamber Rb to lengthen an interval between the adjustment target T and the radar device R. In contrast, in the vehicle inspection system S, as described above, the adjustment target T is installed at an appropriate position and in an appropriate posture, and thus it is possible to shorten the interval between the adjustment target T and the radar device R while securing sufficient adjustment accuracy of the optical axis O. Accordingly, according to the vehicle inspection system S, it is possible to make the inspection chamber Rb compact while adjusting the optical axis O with accuracy.

(2) A position and a posture of the first marker M1 attached to the vehicle body B are different for every vehicle V. Therefore, in the vehicle inspection system S, the confronting devices 15L, 15R, 17L, and 17R secure the confronting posture of the vehicle body B, the first marker position and posture calculation unit 61 calculates the position and the posture of the first marker M1 with reference to the inspection reference point Q defined on the vehicle body B in a state of securing the confronting posture by the confronting devices 15L, 15R, 17L, and 17R, and the position and posture calculation unit calculates the position and the posture of the vehicle body B and the adjustment target T in the inspection chamber Ra by using a detection result of the position and the posture of the first marker M1 and the second marker M2, and the position and the posture of the first marker M1 which are calculated by the first marker position and posture calculation unit 61. In the invention, the first marker position and posture calculation unit 61 calculates the position and the posture of the first marker M1 with reference to the inspection reference point Q in a state of securing the confronting posture by the confronting devices 15L, 15R, 17L, and thus it is possible to calculate the position and the posture of the first marker M1 with reference to the inspection reference point Q with accuracy. In addition, according to this, it is possible to accurately understand an actual position and an actual posture of the vehicle body B in the inspection chamber Rb by the position and posture calculation unit 62, and it is possible to install the adjustment target T at an appropriate position and in an appropriate posture with respect to the vehicle body B installed in the inspection chamber Rb to adjust the optical axis O of the radar device R with accuracy.

(3) In the vehicle inspection system S, the position and posture calculation unit 62 detects the position and the posture of the first marker M1 and the second marker M2 by using a plurality of cameras Cb which are installed with predetermined intervals at an outer periphery of the inspection chamber Rb and images of the first marker M1 and the second marker M2 which are photographed by the plurality of cameras Cb. According to this, it is possible to accurately understand an actual position and an actual posture of the vehicle body B and the adjustment target T in the inspection chamber Rb by the position and posture calculation unit 62, and it is possible to install the adjustment target T at an appropriate position and in an appropriate posture with respect to the vehicle body B installed in the inspection chamber Rb to adjust the optical axis O of the radar device R with accuracy.

(4) In the alignment tester process, the vehicle V is moved to the inspection chamber Ra in which the confronting devices 15L, 15R, 17L, and 17R which secure the confronting posture of the vehicle body B are installed, and the position and the posture of the first marker M1 with reference to the inspection reference point Q are calculated while securing the confronting posture by the confronting devices 15L, 15R, 17L, and 17R in the inspection chamber Ra. Next, the vehicle V is moved to the inspection chamber Rb, the position and the posture of the first marker M1 and the second marker M2 are detected in the inspection chamber Rb, the position and the posture of the vehicle body B and the adjustment target T in the inspection chamber Rb are calculated by using the detected position and posture of the first marker M1 and the second marker M2, and the calculated position and posture of the first marker M1 with reference to the inspection reference point Q, in the inspection chamber Ra, the adjustment target T is moved on the basis of the position and the posture of the vehicle body B and the adjustment target T, and the direction of the optical axis O of the radar device R is adjusted by using the adjustment target T. In the vehicle inspection method, the position and the posture of the vehicle body B and the adjustment target T are calculated by detecting the position and the posture of the first marker M1 and the second marker M2. Accordingly, it is possible to accurately understand an actual position and an actual posture of the vehicle body B and the adjustment target T in the inspection chamber Rb, and thus it is possible to install the adjustment target T at an appropriate position and in an appropriate posture with respect to the vehicle body B in the inspection chamber Rb, and it is possible to adjust the optical axis O of the radar device R with accuracy.

In addition, in the vehicle inspection method, a position and a posture of the first marker M1 with reference to the inspection reference point Q, which are necessary to calculate the position and the posture of the vehicle body B and the adjustment target T in the inspection chamber Rb with accuracy, are acquired in advance in the inspection chamber Ra before moving the vehicle V to the inspection chamber Rb, and thus it is possible to shorten time taken for adjustment of the optical axis O of the radar device R in the inspection chamber Rb.

Hereinbefore, an embodiment of the invention has been described, but the invention is not limited thereto. A detailed configuration may be appropriately modified in a range of the gist of the invention. For example, in the aiming process according to the embodiment, description has been given of a case where a position of the vehicle body B in the inspection chamber Rb is fixed, and the adjustment target T is moved, but the invention is not limited thereto. In the aiming process, the vehicle body B may be moved instead of moving the adjustment target T, and both the adjustment target T and the vehicle body B may be moved.

### EXPLANATION OF REFERENCE NUMERALS

S VEHICLE INSPECTION SYSTEM
1 ALIGNMENT SYSTEM
Ra INSPECTION CHAMBER
Ca CAMERA
15L, 15R, 17L, 17R CONFRONTING DEVICE
3 OPTICAL AXIS ADJUSTMENT SYSTEM
Rb INSPECTION CHAMBER
Cb CAMERA
V VEHICLE
B VEHICLE BODY
Q INSPECTION REFERENCE POINT (REFERENCE POINT)
R RADAR DEVICE (EXTERNAL ENVIRONMENT SENSOR)
Pm LONGEST TARGET DETECTION POINT
P ATTACHMENT POINT
O OPTICAL AXIS (SENSOR AXIS)
On NORMAL OPTICAL AXIS
T ADJUSTMENT TARGET
M1 FIRST MARKER
M2 SECOND MARKER
6 CONTROL DEVICE
61 FIRST MARKER POSITION AND POSTURE CALCULATION UNIT (FIRST MARKER POSITION AND POSTURE CALCULATION UNIT)
62 POSITION AND POSTURE CALCULATION UNIT (POSITION AND POSTURE CALCULATION UNIT)
63 VEHICLE-BODY POSITION AND POSTURE CALCULATION UNIT (POSITION AND POSTURE CALCULATION UNIT)
64 TARGET POSITION AND POSTURE CALCULATION UNIT (POSITION AND POSTURE CALCULATION UNIT)
65 RADAR ATTACHMENT POSITION AND DIRECTION CALCULATION UNIT
66 NORMAL POSTURE CALCULATION UNIT
67 TARGET MOVEMENT UNIT (MOVEMENT UNIT)

What is claimed is:

1. A vehicle inspection system that inspects a vehicle in which an external environment sensor that detects an external environment is attached to a vehicle body, the vehicle inspection system comprising:
an adjustment target that is installed in an inspection area in which the vehicle body is disposed;
a first marker that is attached to the vehicle body;
a second marker that is attached to the adjustment target;
a position and posture calculation unit that calculates a position and a posture of the vehicle body and the adjustment target in the inspection area by detecting a position and a posture of the first marker and the second marker; and
a movement unit that moves at least one of the vehicle body and the adjustment target on the basis of a calculation result of the position and posture calculation unit.

2. The vehicle inspection system according to claim 1, further comprising:
a confronting device that secures a confronting posture of the vehicle body; and
a first marker position and posture calculation unit that calculates the position and the posture of the first marker with reference to a predetermined reference point defined on the vehicle body in a state of securing the confronting posture by the confronting device,
wherein the position and posture calculation unit calculates the position and the posture of the vehicle body and the adjustment target in the inspection area by using a detection result of the position and the posture of the first marker and the second marker, and a calculation result of the first marker position and posture calculation unit.

3. The vehicle inspection system according to claim 1, wherein the position and posture calculation unit detects the position and the posture of the first marker and the second marker by using a plurality of cameras installed with predetermined intervals at an outer periphery of the inspection area, and images of the first marker and the second marker which are photographed by the plurality of cameras.

4. The vehicle inspection system according to claim 2, wherein the position and posture calculation unit detects the position and the posture of the first marker and the second marker by using a plurality of cameras installed with predetermined intervals at an outer periphery of the inspection area, and images of the first marker and the second marker which are photographed by the plurality of cameras.

5. A vehicle inspection method of inspecting a vehicle in which an external environment sensor that detects an external environment is attached to a vehicle body, the vehicle inspection method comprising:
moving the vehicle body to a first inspection area in which a confronting device that secures a confronting posture of the vehicle body is installed;
calculating a position and a posture of a first marker attached to the vehicle body with reference to a predetermined reference point defined on the vehicle body while securing a confronting posture by the confronting device in the first inspection area;
moving the vehicle body to a second inspection area in which an adjustment target to which a second marker is attached is installed;
detecting a position and a posture of the first marker and the second marker in the second inspection area;
calculating a position and a posture of the vehicle body and the adjustment target in the second inspection area by using the detected position and posture of the first marker and the second marker, and the calculated position and posture of the first marker with reference to the reference point;
moving at least one of the vehicle body and the adjustment target on the basis of the calculated position and posture of the vehicle body and the adjustment target in the second inspection area; and
adjusting a direction of a sensor axis of the external environment sensor by using the adjustment target.
